(19) United States
(12) Patent Application Publication
(10) Pub. No.: US 2014/0104312 A1
(43) Pub. Date: Apr. 17, 2014

(54) Creation and Sharing of Digital Postcards Associated with Locations

(71) Applicant: Gogobot, Inc., Mento Park, CA (US)

(72) Inventors: Ori Zaltzman, Menlo Park, CA (US); Travis Katz, Menlo Park, CA (US)

(73) Assignee: Gogobot, Inc., Menlo Park, CA (US)

(21) Appl. No.: 14/034,919

(22) Filed: Sep. 24, 2013

Related U.S. Application Data
(60) Provisional application No. 61/713,613, filed on Oct. 14, 2012.

(51) Int. Cl. G06T 11/60

(52) U.S. Cl. CPC G06T 11/60
USPC 345/632

(57) ABSTRACT

The creation of digital postcards allows users to combine location information with images for display in a postcard interface. An image selection is received from a user. Location data associated with the image and describing a location at which the image was captured is accessed. One or more candidate locations located within a threshold distance of the location are identified, and a selection of a candidate location is received from the user. Location information associated with the selected candidate location is accessed, and the image is modified to include one or more portions of the accessed location information. The modified image is stored as a digital postcard in a memory for subsequent access and display.

### CROSS REFERENCE TO RELATED APPLICATIONS

This application claims the benefit of Provisional Application No. 61/713,613, filed Oct. 14, 2012, which is incorporated herein by reference.

### BACKGROUND

This invention relates to digital cataloging generally, and more specifically to the creation of digital postcards related to activities participated in by users at various locations.

The desire to share experiences with friends has increased with the increased prevalence and sophistication of mobile devices. For example, people take pictures of meals at restaurants to share via social networking systems. Others “check-in” to museums or bars to let people know where they are or have been. Still others create reviews for movie theaters, bowling alleys, and baseball stadiums. However, the chronicling and synchronizing of such activities is often disparate and uncoordinated, resulting in frustration for users of systems implementing such functionalities.

### BRIEF DESCRIPTION OF THE DRAWINGS

FIG. 1 is a high-level block diagram illustrating the creation of a modified image, or “digital postcard”, in accordance with an embodiment of the invention.

FIG. 2 is a network diagram of a system environment for creating digital postcards, in accordance with an embodiment of the invention.

FIGS. 3a-3c illustrate example image modification schemes used in the creation of an example digital postcard, in accordance with an embodiment of the invention.

FIGS. 4a-4c illustrate example user interfaces for use in the display and/or modification of one or more digital postcards, in accordance with an embodiment of the invention.

FIG. 5 is a flowchart of a process for creating a digital postcard, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

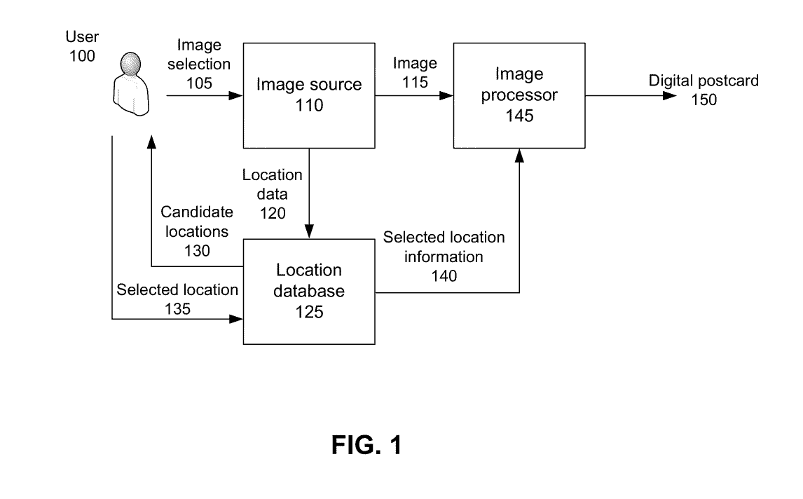

FIG. 1 is a high-level block diagram illustrating the creation of a modified image, or “digital postcard” or just “postcard” herein, in accordance with an embodiment of the invention. The creation of digital postcards as described herein can be performed by a client device, such as camera, mobile phone, personal computer, tablet computer, or any other device including a non-transitory computer-readable storage medium and a processor configured to execute instructions stored on the storage medium. In one embodiment, the creation of digital postcards is performed by an application running on such a client device.

A user 100 selects 105 an image 115 from an image source 110. The image source can be a client device equipped with a camera. In such embodiments, the user can take a picture with the client device of, for example, a vacation location, an event, a restaurant meal, and the like. Alternatively, the image source can be an image database, such as an image repository website, a social networking system, and the like.

Upon the selection of an image 115, location data 120 is provided to a location database 125. The location data includes data describing a location at which the image was captured. The location data can be, for instance, GPS coordinates, longitude and latitude coordinates, or any other geographically descriptive data. The location data can be determined by a GPS receiver in a client device. Alternatively, the location data can be retrieved from the meta-data of an image, for instance from an image taken with a device that includes GPS coordinates within image files. The location data can also be manually inputted by a user 100.

The location database 125, upon receiving the location data 120, retrieves a set of candidate locations 130 from a store of locations. The set of candidate locations can include one or more locations located within a threshold distance of the location described by the location data. For example, upon being queried with the location data, the location database can return a restaurant, a shopping mall, and a park located within 0.2 miles of the location described by the location data. The location database can be, for example, located within a client device used to capture the selected image, or can be an external location database, such as a website dedicated to consumer reviews of locations. The set of candidate locations can be displayed to the user 100, for instance on the display of a client device.

The user 100 selects a candidate location 135 from the set of candidate locations 130. The candidate location selected by the user can represent, for example, the location associated with the image selected by the user. In this example, a user can select an image of a meal eaten at a first restaurant located near three other restaurants. The first restaurant and the three other restaurants can be presented to the user as candidate locations, and the user can select the first restaurant for use in creating a digital postcard.

Information 140 associated with the selected location 135 is accessed in response to the selection of the candidate location. In one embodiment, the location database 125 is queried with the selected location, and information associated with the selected location is returned. The information associated with the selected location can include, but is not limited, a name of the selected location (such as a business name, place name, or entity name), a city in which the location is located, an address associated with the location, a phone number associated with the location, a website associated with the location, a location category (such as “restaurant”, “park”, “school”, etc.) or sub-category (such as “French restaurant”), or any other information associated with the location. The information associated with the selected location can also include information associated with the user 100, such as an identity of the user, a time and date of the capture of the image or that the user visited the location, identities of individuals associated with the user present at the location with the user, or any other information associated with the user.

The image 115 and the selected location information 140 are received by an image processor 145. The image processor modifies the image to include one or more portions of the location information such that when the modified image is displayed, the one or more portions of location information are displayed within or in conjunction with the image. For example, the image processor can modify the image by overlaying text associated with the one or more portions of the location information over the image. In this example, an image of Mount Fuji can be modified to include the text “Mount Fuji” in a corner of the image. The image processor can also perform a variety of other image processing operations, as will be discussed below in greater detail. The image processor can be included within a client device used to capture the image, or can be located in an external entity, such as a personal computer or a cloud image processing service. The modified image is then output by the image processor as a digital postcard 150.

The creation of a digital postcard as described in the embodiment of FIG. 1 allows the user 100 to digitally catalogue activities in which the user participates. For instance, digital postcards can be created during and for trips taken by the user, during events attended by the user, of meals eaten by the user, of hikes and other outdoor activities participated in by the user, and for any other activity in which the user participates. The digital postcards are images modified to include location information associated with the activities participated in by the user. For example, a user can capture an image of a Rolling Stones concert at the Greek Theatre and can modify the image to include the text “The Rolling Stones at the Greek.” Similarly, a user can go on vacation to Hawaii, and can modify an image of a beach to include the text “Aloha from Hawaii.” Digital postcards can also include additional information, such as rating information, review information, date and time information, the names of individuals present with the user at the time of the capture of the image, and the like.

Digital postcards provide users a way to share images and information associated with the activities in which the user participates with others. A user can upload digital postcards to a digital postcard database, such as a database configured to display digital postcards to one or more requesting users. The digital postcard database can include a searchable website configured to display one or more digital postcards in conjunction with information associated with a location associated with the digital postcard. For example, a user can search the keyword “Disneyland”, and digital postcards associated with the amusement park Disneyland can be returned and/or displayed. Continuing with this example, upon the selection of a displayed digital postcard, information associated with the digital postcard is displayed, such as a review of Disneyland by the user that created the digital postcard, a date that the user visited Disneyland, and information about ticket prices.

The digital postcard database can organize digital postcards in guides, where each guide includes a set of related digital postcards, for a particular user or for a group of users. Users can include uploaded digital postcards in pre-existing guides, or they can create their own guides. For example, a user may create a guide for a vacation to Mexico with all digital postcards created from images taken in Mexico. The system may also automatically collect a user's postcards associated with a city or other geographical region into one or more guides (e.g., all postcards associated with San Francisco into a San Francisco guide, and all postcards associated with London into a London guide). Users can browse guides for ideas of activities to participate in when visiting a particular location. Guides also allow users t The guides may be displayed via a website and/or a mobile application associated with the system.

Digital postcards can be shared, for instance through an interface (such as a website) associated with the digital postcard database. Alternatively, digital postcards can be shared via a third party website, a social networking system (e.g., Facebook or Twitter), SMS, email, and the like. For example, the digital postcards can be uploaded to a travel website, such that when a user searches for a particular vacation destination, one or more digital postcards associated with the destination can be displayed in conjunction with information about the destination.

### System Environment

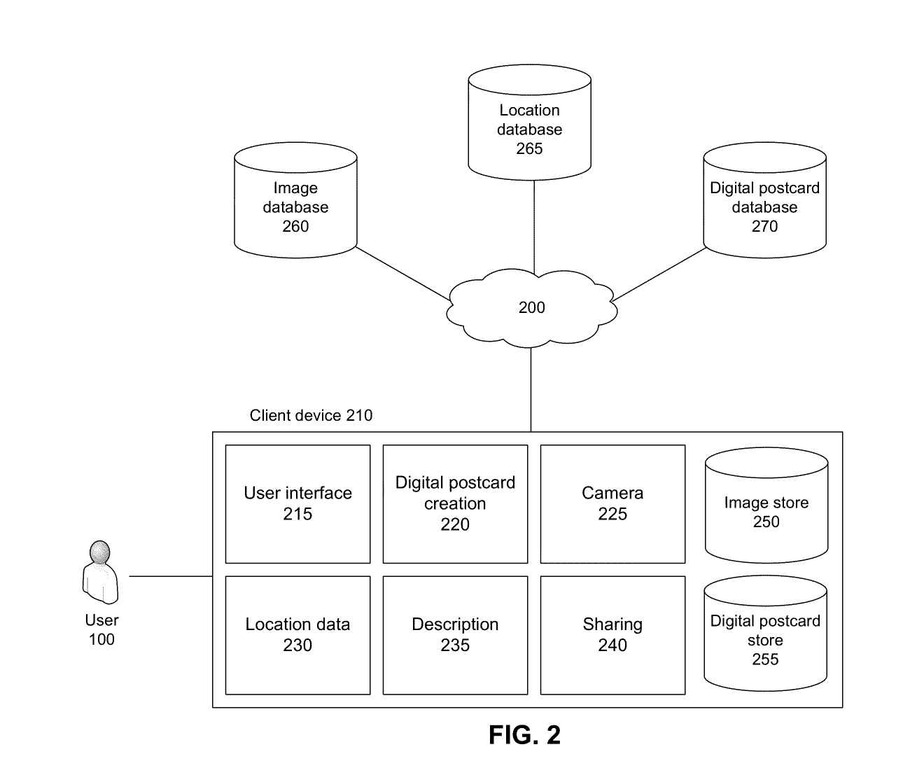

FIG. 2 is a network diagram of a system environment for creating digital postcards, in accordance with an embodiment of the invention. The system environment includes a client device 210, an image database 260, a location database 265, and a digital postcard database 270, each of which are communicatively coupled via the network 200. A user 100 is associated with the client device, and uses the client device to create one or more digital postcards. During the creation of the digital postcards, the client device can communicate with the image database, the location database, and the digital postcards database via the network. The network may be a local area network, a wide area network, the internet, or any other network or combination of networks that allows communication between the entities of FIG. 2. The network may use standard communications technologies and/or protocols and may include wireless and/or wired communication protocols.

The client device 210, as noted above, can be a camera, a mobile phone, a personal computer, a tablet computer, or any other personal device. In such embodiments, the creation of digital postcards can be performed within an application running on the client device. Alternatively, the creation of digital postcards can be performed via a web service accessed via a client device; in such circumstances, the client device 210 can be one or more server computers or a datacenter implementing the functions of the modules of the client device 210. It should be noted that in other embodiments, the system environment includes additional entities not illustrated herein. In addition, it should be noted that the image database 260, the location database 265, and the digital postcard database 270 can include the same database, and one or more of these database can be located within the client device.

The client device 210 of the embodiment of FIG. 2 includes a user interface module 215, a digital postcard creation module (or simply, a “postcard module”) 220, a camera 225, a location data module 230, a description module 235, and a sharing module 240. In addition, the client device 210 includes an image store 250 and a digital postcard store 255. In some embodiments, the client device includes additional or different components than those illustrated herein. For example, the client device may not include a camera or location data module, and may instead receive images and location data from other entities, such as the image database 260 and the location database 265. Similarly, the description module and the sharing module can be implemented in a different entity, such as a digital postcard website associated with the digital postcard database 270, such that a user 100 of the client device, upon creating a digital postcard and uploading the digital postcard to the digital postcard database, can add reviews and ratings to the digital postcard and share the digital postcard with others via the digital postcard website.

The user interface module 215 provides the communicative interface between the client device 210 and the user 100. For instance, communications are sent from the postcard module 220 to the user via the user interface module. The user interface module can present one or more interfaces (such as graphical user interfaces, or GUIs) to the user during the creation of a digital postcard, for instance by display a variety of images to the user to select for use in the creation of a digital postcard via a client device display, by displaying a variety of candidate locations to the user to select for use in the creation of a digital postcard, and the like. Similarly, communications and inputs from the user to the postcard module, for instance in response to the presentation of one or more interfaces to the user, are sent via the user interface module. In one embodiment, the user interface module also provides the communicative interface between the client device and the other entities of the embodiment of FIG. 2.

The postcard module 220 is configured to create one or more digital postcards and to guide a user through the process of creating the one or more digital postcards. A user requests the creation of a digital postcard, and in response, the postcard module prompts a user to select an image for use in the requested digital postcard. The user can select an already captured image (such as an image stored in the image store 250), or can use the camera 225 to capture an image for use in the requested digital postcard. The camera can include a built-in camera as indicated in the embodiment of FIG. 2, such as a phone camera, or can be an external camera communicatively coupled to the client device 210. Images captured by the camera, whether or not the images are captured in response to a request to create a digital postcard from the user, can be stored in the image store for subsequent viewing, editing, or use in creating digital postcards. In one embodiment, in response to the capturing of an image by the user with the camera, the postcard module can prompt a user to create a digital postcard using the captured image.

In one embodiment, instead of using an image captured by the camera 225 or stored at the image store 250, a user 100 can access the image database 260 to select an image. The image database can be an image repository website, a social networking system, a digital file locker, an external hard drive or other non-transitory computer-readable storage medium, a server or data center, or any other entity configured to store one or more images. The user can access, view, and select an image from the image database for instance via the user interface module 215. In one embodiment, the user can browse images captured at locations near the user from the image database by querying the image database with location data describing the user's location using, for instance, the location-detection functionality of the client device 210 (as described below). In response to the selection of an image from the image database, the selected image is sent to the client device via the network 200, and stored in the image store for use in creating a digital postcard by the postcard module 220.

In response to receiving a selection of an image from the user 100, the postcard module 220 accesses location data associated with the selected image. The location data describes a location at which the image was captured. The location data can be GPS coordinates, latitude and longitude coordinates, or any other data describing the location at which the image was captured. The location data can be captured by the location data module 230, which can include a GPS receiver configured to capture GPS coordinates or any other location-detection functionality. For example, in an embodiment where the user captures an image using the camera 225 for use in creating a digital postcard, the location data module can capture GPS at the time of the image capture. The location data module can store captured location data in conjunction with captured images at the image store 250, for instance within metadata of the image file. In embodiments in which the selected image is a previously captured image stored in the image store 250 or at the image database 260, the postcard module can retrieve the location data from the metadata included in the image file. In other embodiments, the location data can be obtained from any other suitable source, or can be manually entered by the user.

The postcard module 220 identifies one or more candidate locations based on the accessed location data. The one or more candidate locations can include locations located within a threshold distance of the location described by the location data. The candidate locations can be identified by querying the location database 265 with the location data. The location database includes pre-defined locations (for instance, thousands or millions) associated with particular location data, such as GPS coordinates. For example, the location database may include restaurants, bars, coffee shops, other businesses, parks, stadiums, malls, monuments, historical locations, roadways, geographical features, bodies of water, houses or other places of residence, and the like, each associated with particular GPS coordinates. Upon being queried with the location data, the location database can return a set of candidate locations nearest the location described by the location data. The returned candidate locations can be all pre-defined locations located within a threshold distance of the location described by the location data, the most relevant pre-defined locations within a threshold distance of the location described by the location data, and the like. The threshold distance used by the location database 265 from the location described by the location data can be based on the number of pre-defined locations located near the location described by the location data, can be based on the location described by the location data, can be based on user input or preference, or can be based on any other suitable factor.

The postcard module 220 can present the candidate locations to the user 100 via the user interface 215, and the user can select a candidate location for use in creating the requested digital postcard. The candidate locations can each be associated with a location name, and displaying the candidate locations to the user can include displaying the location names to the user, for instance in alphabetical order, based on the distance between each candidate location and the location described by the location data, or the like. In one embodiment, the user selects the candidate location associated with the selected image for use in creating the requested digital postcard. For instance, if the selected image is an image of a lake, the user can select the candidate location associated with the lake. If a user prefers not to use a presented candidate location, the user can request additional candidate locations (in response to which the postcard module retrieves additional candidate locations from the location database), or can choose to define a location for use in creating the requested digital postcard (in response to which the user can enter a name of the location or any other information associated with the location).

The postcard module 220 accesses location information associated with the selected location. In one embodiment, the postcard module queries the location database 265 with the selected location to obtain location information associated with the selected location. The location database, in addition to including pre-defined locations, can include location information associated with each pre-defined location, such as a name of the selected location (such as a business name, place name, or entity name), a city in which the location is located, an address associated with the location, a phone number associated with the location, a website associated with the location, a location category (such as “restaurant”, “park”, “school”, etc.) or sub-category (such as “French restaurant”), or any other information associated with the location. In some embodiments, the postcard receives the location information associated with the selected location when the postcard module initially queries the location database for candidate locations. In these embodiments, the location database provides location information associated with each candidate location returned to the postcard module, and the postcard module accesses the received location information associated with the selected location in response to receiving the location selection from the user 100. It should be noted that in other embodiments, the postcard module queries a location information source other than the location database to obtain location information associated with selected information. In some embodiments, the user can provide location information associated with the selected information.

The location information associated with the selected location accessed by the postcard module 220 can also include information associated with the user 100. For instance, the location information can include an identity of the user, a user name of the user, a time and date of the capture of the image or that the user visited the location, identities of individuals associated with the user present at the location with the user, or any other information associated with the user. Location information associated with the selected location and associated with the user can be entered by the user, or can be retrieved from an external source, such as a social networking system, a website, and the like.

The postcard module 220 modifies the selected image using the accessed location information to create a digital postcard. The modification of the selected image can include the altering of the image to include one or more portions of the location information within the image such that the one or more portions of the location information are displayed when the modified image is displayed. For example, if the name of the selected location is “The Empire State Building”, the text “The Empire State Building” can be overlaid on the selected image, for instance in a corner of the image, across the top of the image, and the like. Similarly, if the user 100 visited the Empire State Building on Dec. 28, 2011, the text “12/28/11” can also be overlaid on the image.

The type of image modification performed by the postcard module 220 can be selected by the user 100. The postcard module can present a variety of potential image modification schemes to the user. The image modification schemes can identify the location of the text to be overlaid on the image, the type of the text to be overlaid on the image (for instance, the name of the selected location, the city of the selected location, the identity of the user, and the like), the properties of the text to be overlaid on the image (such as the color of the text, the font of the text, the size of the text, and the like), and any graphics accompanying the text (such as one or more banners or blocks overlaid below the text but above the image, and the properties of such banners or blocks). The image modification schemes presented to the user can be pre-defined. Alternatively, the user can create an image modification scheme, defining what text is displayed on the image, the properties and location of the text display, and the like. User-created image modification schemes can be stored by the postcard module for subsequent use.

The image modification schemes presented to and selected by a user 100 and performed by the postcard module 220 can also include one or more image processing operations. The image processing operations included in the image modification schemes can create image “effects” to simulate one or more image capture conditions. In one embodiment, the image processing operations involve the application of a digital filter to the image. For example, filters can be applied to saturate certain colors in the image, to fade certain colors in the image, to blur portions of the image, to simulate high exposure within the image, to increase or decrease image contrast, to “wash out” colors in the image, to sharpen the image, to simulate film camera effects, to simulate “retro” camera effects, the like. Additional image processing operations included in image modification schemes can also include the zooming of portions of the image, the cropping of the image, the upscaling or downscaling of an image, the combination of multiple images, the inclusion of clip art or other graphics, and the like. In one embodiment, the postcard module lets a user preview the effects of image modification schemes before selecting a scheme for use in creating the digital postcard.

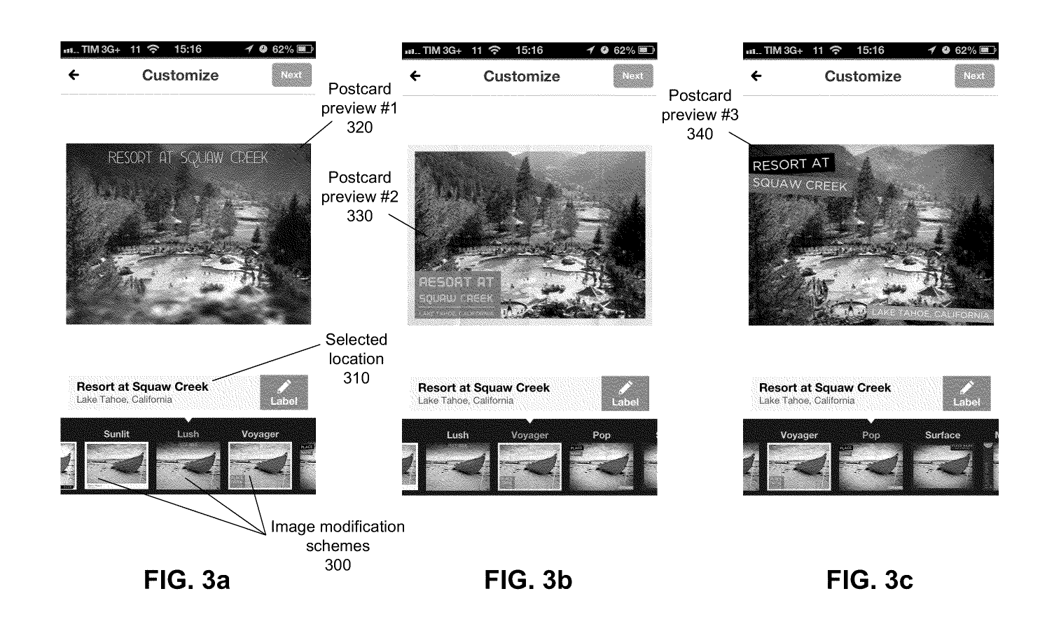

FIGS. 3a-3c illustrate example image modification schemes used in the creation of an example digital postcard, in accordance with an embodiment of the invention. The embodiments of FIGS. 3a-3c show a variety of image modification schemes 300 within an interface displaying the selected image and the selected location. The selected image in these embodiments is an image of a swimming pool at a resort in a mountain setting. The selection location 310 is the Resort at Squaw Creek. In the embodiments of FIGS. 3a-3c, a user can select an image modification scheme and can preview the selected image modification scheme in a preview window.

The image modification scheme selected for preview in the embodiment of FIG. 3a is called “Lush.” The preview 320 of the digital postcard in the embodiment of FIG. 3a illustrates the modification of the image according to the Lush image modification scheme, which includes the blurring of the image at the borders of the image, the darkening of portions of the image, and the saturation of yellow colors in the image. In addition, the Lush image modification scheme includes overlaying the image with location information associated with the selected location, namely the text “Resort at Squaw Creek” over the top portion of the image in a thin, white font.

The image modification scheme selected for preview in the embodiment of FIG. 3b is called “Voyager.” The preview 330 of the digital postcard in the embodiment of FIG. 3b illustrates the modification of the image according to the Voyager image modification scheme, which includes the inclusion of an off-white border around the image and the simulation of a “folded map” effect by including mock vertical fold marks dividing the image into quarters. In addition, the Voyager image modification scheme includes overlaying the image with a turquoise block in the lower left of the image, and overlaying the turquoise block with location information associated with the selected location, namely the text “Resort at Squaw Creek” and the city and state of the selected location, namely “Lake Tahoe, Calif.”, in a white font and separated by a horizontal white line.

The image modification scheme selected for preview in the embodiment of FIG. 3c is called “Pop.” The preview 340 of the digital postcard in the embodiment of FIG. 3c illustrates the modification of the image according to the Pop image modification scheme, which includes the darkening of the image at the corners of the image. In addition, the Pop image modification scheme includes overlaying the image with a black and pink partial banner in the upper left corner of the image, and with a blue partial banner in the lower right corner of the image. The Pop image modification scheme further includes overlaying the banners with location information associated with the selected location, namely the text “Resort at Squaw Creek” on the black and pink banners and the city and state of the selected location, namely “Lake Tahoe, Calif.” on the blue banner, each in a white font.

Returning to FIG. 2, after the postcard module 220 modifies the selected information with one or more portions of the location information associated with the selected information to create the requested digital postcard, the postcard module can store the digital postcard in the digital postcard store 255, or can output the digital postcard to the digital postcard database 270 for storage. The digital postcard store can allow the user to view, modify, share, delete, or upload stored digital postcards, for instance via the user interface module 215 or the postcard module. Similarly, the digital postcard database can be configured to allow the user to view, modify, share, or delete previously uploaded digital postcards, either created by the user, or created by other users. As described above, the digital postcard database can be a website configured to allow users to search through digital postcards, view the postcards of others, download postcards to the client device 210, and the like. Users can search the digital postcard database for post cards for instance based on the locations associated with the postcards (e.g. finding postcards associated with nearby locations), based on featured postcards, based on postcard popularity, based on the most “liked” postcards, based on a category of location associated with the postcards, based on the creator or uploader of the postcards, based on friends of the users, and the like. Users can interact with digital postcards uploaded to the digital postcard database, for instance by liking the postcards, commenting on the postcards, sharing the postcards, downloading the postcards, and the like. Users can also add postcards to a trip, itinerary, or schedule, for instance to identify and organize potentially relevant postcards for quick retrieval during future activities in which the users will participate. Postcards stored at the digital postcard database can be displayed to viewing users individually, as thumbnails, in a grid, as a slideshow, and the like.

The digital postcard store 255 and/or the digital postcard database 270 can organize (or can allow users to organize) related digital postcards into sets referred to as “guides.” Each guide includes one or more related postcards, generally associated with a common location, a common geographic location, a common user or set of users, and the like. As described above, a user can create a guide for a particular vacation, and all digital postcards created from images captured on the vacation. Digital postcards can be browsed by guide, beneficially allowing view users to browse digital postcards associated with particular locations that the viewing users might visit, created by users that the viewing users trust, and the like.

The user 100 can create reviews and ratings for the selected location associated with a digital postcard using the description module 235. The description module can prompt a user to create a review and/or rating upon the creation of a digital postcard, upon the viewing of a digital postcard, upon the editing of a digital postcard, and the like. The user can write a review for the selected location using the client device input means (such as a physical keyboard, a virtual keyboard, a keypad, and the like) via the user interface module 215. Similarly, the user can assign a rating to the selected location, for instance a numerical rating (such as a rating of 1 to 5), an alphanumeric rating (such as a grade between A and F), a star rating (such as 1 star to 5 stars), and the like. A review and rating entered via the description module 235 can be stored in association with the digital postcard, for instance within the metadata of the digital postcard file. In one embodiment, the user can further modify a digital postcard via the postcard module 220 to include a display of a rating or a portion of a review when the digital postcard is displayed.

The user 100 can share one or more digital postcards with other users using the sharing module 240. The user can identify one or more other users (“target users”) with whom to share one or more selected digital postcards, and the sharing module can transmit the selected digital postcards to the target users. Alternatively, the sharing module can upload the selected digital postcards to the digital postcard database 270, and can communicate to the digital postcard database the identities of the target users with whom to share the selected digital postcards. In response, the digital postcard database can allow the target users to access the selected digital postcards. The sharing module can allow the user to share digital postcards with any other users of an application executed by the client device 210 to implement the functionalities described herein to create digital postcards, and/or with any other users of the digital postcard database. In other embodiments, the sharing module allows the user to share digital postcards via third party websites, digital postcard repositories, social networking systems, email, or any other means of sharing digital postcards.

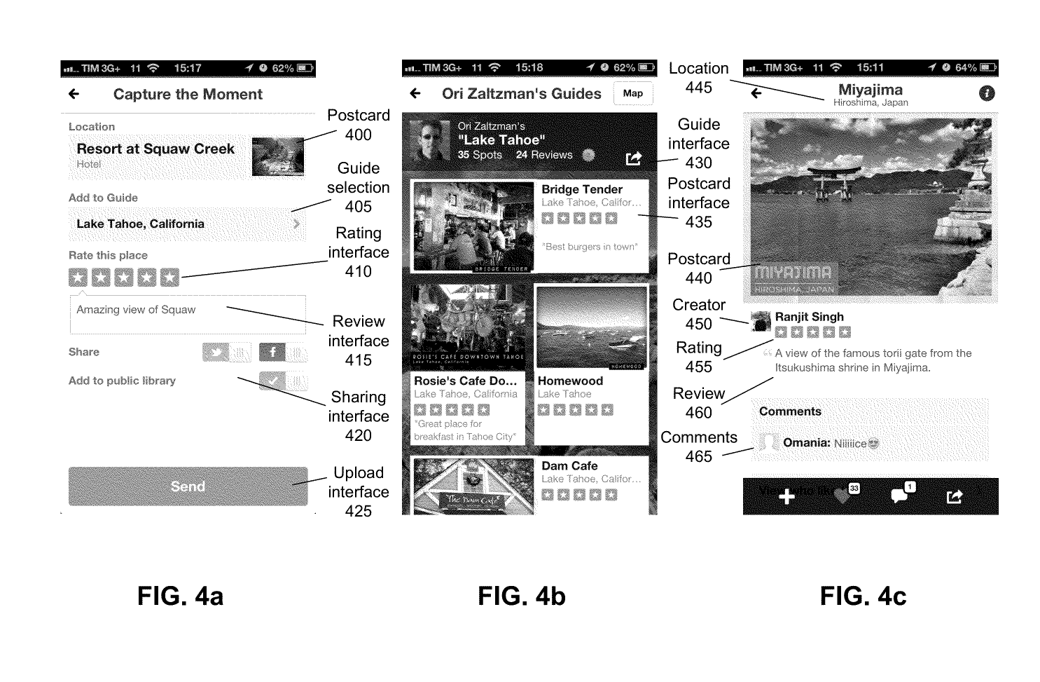

FIGS. 4a-4c illustrate example user interfaces for use in the display and/or modification of one or more digital postcards, in accordance with an embodiment of the invention. In the embodiment of FIG. 4a, information associated with a digital postcard 400 is displayed in an interface. A thumbnail image of the digital postcard is displayed at the top of the interface near the name of the selected location associated with the postcard (the Resort at Squaw Creek) and a location category associated with the selected location (“hotel”). It should be noted that the postcard of the embodiment FIG. 4a is the postcard displayed in the postcard preview 340 of the embodiment of FIG. 3c.

The interface of the embodiment of FIG. 4a includes a guide selection interface 405. The user 100 can use the guide selection interface add the postcard 400 to a selected guide. In the embodiment of FIG. 4a, the postcard is added to the “Lake Tahoe, Calif.” guide. The interface of the embodiment of FIG. 4a further includes a rating interface 410 and a review interface 415. The rating interface allows the user to select a rating for the selected location (the Resort at Squaw Creek) to associate with the postcard from between one star and five stars. In the embodiment of FIG. 4a, a rating of five stars is given to the Resort at Squaw Creek. The review interface allows the user to create a review for the selected location to associate with the postcard. In the embodiment of FIG. 4a, a review of “Amazing view of Squaw” is given to the Resort at Squaw Creek. The interface of the embodiment of FIG. 4a further includes a sharing interface 420 configured to allow the user to share the digital postcard via the one or more social networking systems, and an upload interface 425 (in the form of a “send” button) configured to confirm the sharing of the postcard with other users or the uploading of the postcard to a digital postcard database.

The interface of the embodiment of FIG. 4b includes a guide interface 430 displaying a guide called “Lake Tahoe.” The guide interface displays the name and image of the creator of the guide, along with the number of postcards in the guide (35) and the number of reviews made for locations represented by postcards in the guide (24). The guide interface of the embodiment of FIG. 4b also displays postcards and information associated with the locations associated with the postcards in a plurality of postcard interfaces for postcards belonging to the guide. For instance, the guide interface displays a postcard interface 435 including a postcard and information associated with the postcard, namely a name of the location associated with the postcard (“Bridge Tender”), a city and state of the location (Lake Tahoe, Calif.), a rating for the location (5 stars), and a portion of a review for the location (“Best burgers in town”). The postcard interfaces displayed in the guide interface of the embodiment of FIG. 4b can be selectable, and the selection of a postcard interface can result in the display of additional information associated with each postcard.

The interface of the embodiment of FIG. 4c includes a display of a postcard and information associated with the postcard. In one embodiment, the interface of the embodiment of FIG. 4c is displayed in response to the selection of a postcard interface in the embodiment of FIG. 4b. The interface of the embodiment of FIG. 4c includes the display of a postcard 440, a name of the location 445 associated with the postcard (“Miyajima”, Hiroshima, Japan), a creator 450 of the postcard, a rating 455 of the location associated with the postcard (5 stars), a review 460 of the location associated with the postcard (“A view of the famous torii gate from the Itsukushima shrine in Miyajima”), and a comments interface 465 displaying comments made by users that have viewed the postcard.

### Operation

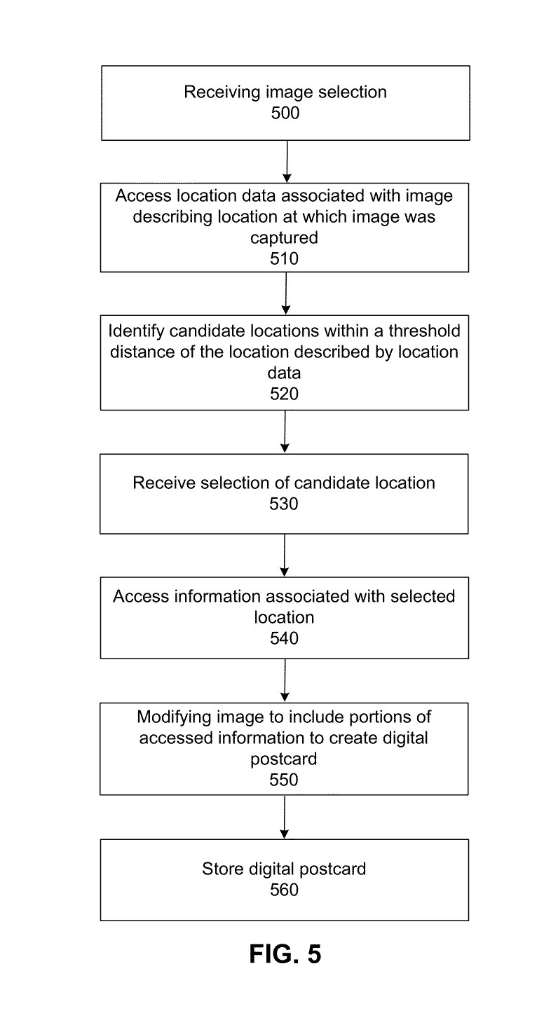

FIG. 5 is a flowchart of a process for creating a digital postcard, in accordance with an embodiment of the invention. In the embodiment of FIG. 5, an image selection is received 500. The image can be selected from a camera or other client device used to capture the image, or an image can be selected from an external image database, such as an online image repository. Location data is accessed 510 associated with the image and describing the location at which the image was captured. The location data can be, for example, GPS coordinates captured by the client device used to capture the image or parsed from the image metadata.

One or more candidate locations located within a threshold distance of the location described by the location data are identified 520. The candidate locations can be retrieved from a location database by querying the location database with the location data. The candidate locations can include, for instance, restaurants, parks, businesses, hiking trails, beaches, concert venues, and the like. The candidate locations can be displayed to a user, for instance on the display of a mobile device. A candidate location selection is received 530 from the user, for instance representing the location associated with the image selected by the user.

Information associated with the selected location is accessed 540. For instance, the name and address of the location, contact information associated with the location, and the like. The information associated with the selected location can also include information associated with the user creating the digital postcard, such as the identity of the user, the time and date the user visited the location, and the like.

The image is modified 550 to create a digital postcards, wherein modifying the image includes including one or more portions of the accessed information such that when the digital postcard is displayed, the one or more portions of the accessed information are displayed. Modifying the image can include overlaying the image with text associated with the one or more portions. For instance, if the image is of a beach in Lake Tahoe, the text “Lake Tahoe” can be displayed over the image. Additional image modifications can be made including one or more image processing operations selected by the user and performed on the image. The digital postcard is stored 560 as a digital postcard in a digital postcard database.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a selection of an image from a user;
accessing location data associated with the image, the location data describing a location at which the image was captured;
identifying one or more candidate locations located within a threshold distance of the location described by the location data;
receiving a selection of a candidate location from the user;
accessing location information associated with the selected location;
modifying the image to create a digital postcard, wherein modifying the image comprises combining one or more portions of the location information including textual content describing the selected candidate location within the image such that the one or more portions of the location information are displayed when the digital postcard is displayed; and
storing the digital postcard in a non-transitory computer-readable storage medium.

2. The method of claim 1, wherein the image is captured by the user with a client device.

3. The method of claim 2, wherein the location data is captured by a GPS receiver within the client device.

4. The method of claim 1, wherein the image is selected from among a plurality of images stored at an image repository website.

5. The method of claim 1, wherein the location data is included within metadata of the image.

6. The method of claim 1, wherein identifying one or more candidate locations comprises:
querying a location database with the location data; and
receiving one or more candidate locations from the location database.

7. The method of claim 1, further comprising:
displaying the one or more candidate locations to the user;
wherein receiving a selection of a candidate location comprises receiving a selection of a displayed candidate location.

8. The method of claim 1, further comprising associating the selected candidate location with the digital postcard.

9. The method of claim 1, wherein accessing location information comprises querying a location database with the selected candidate location.

10. The method of claim 1, wherein the accessed location information comprises one or more of: a location name, a city in which the location is located, an address of the location, a location category, and a time or date of image capture.

11. The method of claim 1, wherein modifying the image comprises overlaying text associated with the location information over the image.

12. The method of claim 1, wherein modifying the image further comprises performing one or more image processing operations on the image.

13. The method of claim 1, further comprising receiving a location rating from the user.

14. The method of claim 13, wherein modifying the image further comprises including the location rating within the image such that the location rating is displayed when the digital postcard is displayed.

15. The method of claim 1, further comprising receiving a location review from the user.

16. The method of claim 13, wherein modifying the image further comprises including one or more portions of the location review within the image such that the one or more portions of the location review are displayed when the digital postcard is displayed.

17. The method of claim 1, further comprising:
receiving a selection of a guide from a user from a plurality of guides, each guide associated with one or more digital postcards; and
associating the digital postcard with the selected guide.

18. The method of claim 1, further comprising:
uploading the digital postcard to a digital postcard database, the digital postcard database comprising a plurality of digital postcards and configured to display one or more digital postcards to requesting users.

19. The method of claim 18, wherein the digital postcard database comprises a searchable website configured to allow requesting users to search for digital postcards.

20. The method of claim 1, further comprising:
receiving a selection of a target user from the user; and
sharing the digital postcard with the target user.

21. A system comprising:
an input configured to receive a selection of an image from a user and to receive a selection of a candidate location from the user;
a location interface configured to:
access location data associated with the image, the location data describing a location at which the image was captured;
identify one or more candidate locations located within a threshold distance of the location described by the location data;
present the identified candidate locations to the user; and
access location information associated with the selected candidate location; and
a digital postcard engine configured to:
modify the image to create a digital postcard, wherein modifying the image comprises combining one or more portions of the accessed location information including textual content describing the selected candidate location within the image such that the one or more portions of the location information are displayed when the digital postcard is displayed; and
store the digital postcard in a non-transitory computer-readable storage medium.

22. A non-transitory computer-readable storage medium comprising computer-executable instructions, the instructions including instructions for:
receiving a selection of an image from a user;
accessing location data associated with the image, the location data describing a location at which the image was captured;
identifying one or more candidate locations located within a threshold distance of the location described by the location data;
receiving a selection of a candidate location from the user;
accessing location information associated with the selected location;
modifying the image to create a digital postcard, wherein modifying the image comprises combining one or more portions of the location information including textual content describing the selected candidate location within the image such that the one or more portions of the location information are displayed when the digital postcard is displayed; and
storing the digital postcard in a second non-transitory computer-readable storage medium.
